(19) United States
(12) Patent Application Publication
(10) Pub. No.: US 2025/0170451 A1
(43) Pub. Date: May 29, 2025

(54) RODEO EVENT TIMING SYSTEM

(71) Applicant: Halle Jean HLADKY, Gillette, WY (US)

(72) Inventor: Halle Jean HLADKY, Gillette, WY (US)

(21) Appl. No.: 18/962,531

(22) Filed: Nov. 27, 2024

Related U.S. Application Data
(60) Provisional application No. 63/603,392, filed on Nov. 28, 2023.

(51) Int. Cl. A63B 24/00; A01K 15/00; A01K 27/00; A63B 71/06; B68C 1/00; B68C 1/02

(52) U.S. Cl. CPC A63B 24/0062; A01K 15/003; A01K 27/001; A63B 71/0686; A63B 2024/0068; B68C 2001/007; B68C 1/02

(57) ABSTRACT

A rodeo event timing system having a neck collar adapted to extend around a neck of a calf, a first cable having one end affixed adjacent one end of the neck collar, a second cable having one end affixed adjacent another end of the neck collar, and a switch assembly secured to opposite ends of the first cable and the second cable. The switch assembly is adapted to separate when the ends of the neck collar separate so as to produce a start timing signal. The switch is a magnetic switch having a ball-and-socket configuration.

### CROSS-REFERENCE TO RELATED APPLICATIONS

The present application claims priority from U.S. Provisional Patent Application Ser. No. 63/603,392 filed on Nov. 28, 2023.

### FIELD OF THE INVENTION

The present invention relates to rodeo events and to the ropes associated with said rodeo events. More particularly, the present invention relates to the timing of various rodeo events, such as steer wrestling, team roping, tie-down roping and breakaway roping. Additionally, the present invention relates to the timing of such rodeo events.

### BACKGROUND OF THE INVENTION

In recent times, the prize money for top times in team roping, steer roping, calf roping and breakaway roping have escalated rapidly. Competition now exists for all levels of roping skills from world-class ropers down through beginners. Currently, the prize money in the team roping finals competition may be as much as $180,000 per roper or more. The purse is usually broken down stepwise for six places, with the top time getting 29% and the sixth best time getting 5%. Competitive ropers are handicapped similar to golfers so that the competitive roper competes with those having similar handicaps.

Team roping is the only rodeo event where two cowboys compete as partners, each sharing victory or defeat on the back of a horse. The “header” ropes a steer's horns and rides to the left. Then the “heeler” goes to work, roping both of the steer's hind legs in one of the most difficult maneuvers in rodeo. The ropers must each “dally” (wrap the rope around their saddle horn) after their head or heel catches. The time clock stops when both horses are facing the steer with ropes dallied. A five second penalty is assessed if the heeler catches only one of the steer's hind legs. In ranching practice, large cattle would be roped and taken down in this manner and one or more ranch hands or a veterinarian would rush to the immobile animal to mark, vaccinate or treat the animal for some malady.

Calf roping, which can be traced directly to the ranch work of catching calves for branding or medical treatment, has evolved into one of professional rodeo's quickest and most exciting events. The calf gets a designated head start into the rodeo arena and must trip a barrier string before the cowboy and horse can begin the chase. Once in the arena, the roper must “catch” his calf with his lariat, dismount, run to the calf, drop the animal to the arena floor, gather three of the calf's legs and tie them together with a six-foot “pigging” string and throw up his hands to signal the end of the run.

Steer roping, which derives from ranch work of a single cowboy having to immobilize a larger steer for medical treatment or other reason, has also evolved into a very competitive rodeo event. The steer gets a designated head start into the arena and is then chased and lassoed around the head or horns after which the roper rides up to the left side of the steer, throws the rope over the hind side of the steer and rides left, which trips or throws the steer to the ground. The roper then quickly jumps off the horse while the horse keeps tension on the rope and quickly ties three of the steer's legs together with a “pigging string” and throws his hands up signaling the end of the run.

Breakaway roping is a variation of calf roping where a calf is roped, but not thrown and tied. It is a rodeo event that features a calf and one mounted rider. The calves are moved one at a time through narrow runs leading to a chute with spring-loaded doors. The horse and rider wait in a box next to the chute that has a spring-loaded rope, known as the barrier, stretched in front. A light rope is fastened from the chute to the calf's neck, releasing once the calf is well away from the chute and releasing the barrier, which is used to ensure that the calf gets a head start. Once the barrier has released, the horse runs out of the box while the roper attempts to throw a lasso around the neck of the calf. Once the rope is around the calf's neck, the roper signals the horse to stop suddenly. The rope is tied to the saddle horn with a string. When the calf hits the end of the rope, the rope is pulled tight and the string breaks. The breaking of the string marks the end of the run. The rope usually has a small white flag at the end that makes the moment the rope breaks more easily seen by the timer. The fastest run wins.

Steer wrestling (also known as bulldogging) is another rodeo event. In steer wrestling, a mounted cowboy (or bulldogger) races alongside and then tackles a full-grown steer. The event starts with the bulldogger and his hazer (a second rider who keeps the steer running straight) on either side of the steer's chute. The steer has a head start, which is maintained by a rope around the steer that is tied to a barrier in front of the two riders' horses; there is a 10-second penalty for a broken barrier. The cowboy races beside the steer, reaches down to grasp its horns, and slides off his horse. With legs forward the cowboy digs in his heels, stopping the steer, and twists it to the ground. Time is called when the steer is flat on its side with all four legs and head in the same direction. The contestant with the fastest time wins.

Since the beginning of organized rodeo competition, a person mounted on the horse (referred to as a “rodeo flagger”) has been positioned within the rodeo arena to serve as the referee during a particular rodeo event, such as, for example, bull riding, team roping, calf roping, steer wrestling, team penning, breakaway roping, and barrel racing events. The rodeo flagger moves a flag in a certain movement pattern to signal when a rodeo event clock should be stopped or to signal when certain penalty should be applied. A person positioned outside the rodeo arena (referred to as the “timekeeper”) watches the signals of the rodeo flagger and manually stops the rodeo event clock when he or she sees the appropriate signals of the rodeo flagger. The delay between the occurrence of the rodeo flagger's signals and the actual stopping of the clock by the timekeeper can result in significant errors in the time assigned to rodeo event participants.

Further, in some rodeo competitions, a flag (referred to as a “barrier flag”) is mounted on a rope (referred to as a “barrier rope”) in front of the horse's starting box and is used to signal the timekeeper to manually start the rodeo event clock when either the horse breaks through the barrier rope or the animal reaches its designated head start and the barrier rope is released by a mechanical mechanism. The timekeeper, who is positioned outside the arena, watches for the barrier rope to be released (or broken through) and the flag to drop, which signals the timekeeper to manually start the rodeo event clock. The delay between the occurrence of the flag dropping and the actual starting of the clock by the timekeeper can result in significant errors in the times assigned to rodeo event participants.

Given the increased value of prizes and the larger number of participants in rodeo events, the random timing errors described above can significantly impact the results of important high-stakes rodeo events. There is a need in the art for systems that can quantitively assess performance during rodeo events. There is also a need to reduce or eliminate random timing errors associated with the results of timed rodeo events.

In the past, various patents have issued relating to these rodeo events. For example, U.S. Pat. No. 5,806,469, issued on Sep. 15, 1998 to Cooper-Ratliff et al., describes a breakaway loop for lariats. This breakaway loop has a heel with a throat through which the rope passes and a tapered throat that forms a cavity containing a knot in the rope. Teeth and/or ridged projections inside the throat retain the rope in position. An axis of the throat is at an angle to a centerline through the heel. Resilient arms extend from the heel at an angle to the centerline axis of the heel and curves toward each other so that the distal ends of the arms almost meet. This defines a slit between the arms. Tapered surfaces on the end of each resilient arm cooperate to form a shallow V-shaped indentation on an inner surface of the eye to guide the rope into the slit so that a strong pull will force the rope through the slit, thereby releasing the rope.

U.S. Pat. No. 7,703,415, issued on Apr. 27, 2010 to P. D. Gentry, teaches a rodeo release chute apparatus for use in steer or calf roping competitions. The chute has a fixed end and a movable section that telescopes forwardly relative to the fixed section. A release gate at the forward end of the movable section is movable between a closed position for retaining a steer or calf inside the chute and an open position releasing the steer or calf from the chute. A sensor at the rearward end of the fixed section senses the presence of the horse of the roper at the rearward end of the fixed section. Only when the roper's horse is at the rearward end of the fixed section can the gate be released to release the calf.

U.S. Patent Application Publication No. 2013/0171595, published on Jul. 4, 2013 to Glover et al., describes a rope connecting device for use in calf roping or breakaway roping. The device includes a stem with a first hooked formed at one end and a second hook formed at the other end. The hooks each have a small gap separating respective free ends of the hooks from the stem. During use, a portion of the rope is passed through the first hook as another portion of the rope is passed through the second hook. When sufficient force is applied to the rope, the force causes one of the hooks to open to a degree allowing the rope to pass through, thereby releasing the rope from an object that was lassoed. The device remains attached to the rope at the other hook.

U.S. Patent Application Publication No. 2016/0349711, published on Dec. 1, 2016 to Gwynn et al., teaches a rodeo flag assembly for selectively transmitting instructions to a rodeo clock event. Movement of the rodeo flag assembly causes the rodeo flag assembly to automatically start the rodeo event clock, automatically stop the rodeo event clock and/or automatically apply penalties against a rodeo competitor.

U.S. Patent Application Publication No. 2017/01120797, published on Apr. 27, 2017 to J. S. Jasper, shows an automatically resetting rodeo barrier training and desensitizing device. The device is constructed to train horses to properly act with respect to rodeo barriers in performance of certain rodeo contests, such as steer roping and calf roping. The device further trains horses to be accustomed to stimulation to their legs and body so that the horse will not succumb to panic or to a flight reaction. The barrier arm rotates about a support member allowing the animal to pass therethrough. After the animal has moved therethrough, the barrier arm is returned automatically to a resting position.

It is an object of the present invention to provide a rodeo event timing system that precisely times rodeo events.

It is another object of the present invention to provide a rodeo event timing system that reduces human errors associated with the timing of these rodeo events.

It is a further object of the present invention provide a rodeo event timing system that is easy to apply to the horse and to the calf.

It is another object of the present invention to provide a rodeo event timing system that makes use of existing rodeo event equipment.

It is still a further object of the present invention to provide a rodeo event timing system which is easy to use, easy to manufacture, and is relatively inexpensive.

These and other objects and advantages of the present invention will become apparent from a reading of the attached specification and appended claims.

### SUMMARY OF THE INVENTION

The present invention is a rodeo event timing system for use in association with breakaway roping, steer wrestling, team roping, tie-down roping and various other rodeo events. In particular, this rodeo event timing system is adapted, in this embodiment, to signal the start of the event. This rodeo event timing system comprises a neck collar adapted to extend around the neck of the calf, a first cable having one end affixed adjacent to the first end of the neck collar, a second cable having one end affixed adjacent to the second end of the neck collar, and a switch assembly secured to opposite ends of the first cable and the second cable. The neck collar has ends releasably secured together by a string. The switch assembly is adapted to separate when the ends of the neck collar separate so as to produce a start timing signal. As used herein, the term “calf” can also refer to a steer, a cow, or a bull.

In this embodiment of the present invention, the switch assembly is a magnetic switch. The switch assembly includes a transmitter positioned adjacent to the opposite end of the first cable and the second cable. The transmitter is adapted to transmit the start timing signal to a remote location. The switch assembly comprises a ball positioned at an opposite end of one of the first and second cables and a socket positioned at the opposite end of the other of the first and second cables. The ball is releasably engaged with the socket. The releasing of the ball from the socket causes the start timing signal. The transmitter is positioned in a box positioned rearwardly of the ball. A memory is positioned on one of the first and second cables. The memory is adapted to receive the start timing signal.

This embodiment of the rodeo event timing system of the present invention further includes a first clamp affixed to the one end of the first cable. This first clamp is adapted to engage with the neck collar. A second clamp is affixed to the one end of the second cable. The second clamp is adapted to engage with the neck collar.

For breakaway roping, in particular, the present invention describes a second embodiment in which both the start timing signal and the stop timing signal are produced. The rodeo event timing system of this embodiment includes a neck collar adapted to extend around the neck of the calf, a first cable having one end affixed adjacent to the first end of the neck collar, a second cable having one end affixed adjacent to the second end of the neck collar, a first switch assembly secured to opposite ends of the first cable and the second cable, a saddle having a saddle horn, a third cable having one end secured to the saddle horn, a lasso, a fourth cable having one end secured to the lasso, and a second switch assembly connected to opposite ends of the third cable and the fourth cable. The first switch assembly is adapted to separate when the ends of the neck collar separate so as to produce a start timing signal. The second switch assembly is adapted to separate when the lasso separates from the saddle horn so as to produce a stop timing signal.

In this second embodiment of the present invention, a second switch assembly is also a magnetic switch. The lasso is secured by a breakaway string to the saddle horn. The second switch assembly includes a transmitter positioned adjacent to the opposite ends of the third cable and the fourth cable. This transmitter is adapted to transmit the stop timing signal to a remote location. The second switch assembly includes a ball positioned at an opposite end of the third and fourth cables and a socket positioned at an opposite end of the other of the third and fourth cables. The ball is releasably engaged with the socket. The releasing of the ball from the socket creates the stop timing signal.

The transmitter is positioned in a box positioned rearwardly of the ball. A memory is positioned on one of the third and fourth cables. The memory is adapted to receive the stop timing signal. A third clamp is affixed to one end of the third cable. A fourth clamp is affixed to the one end of the third cable.

In this embodiment of the present invention, the lasso has a flag thereon. A lead rope is affixed to the neck rope. The lead rope is adapted to connect with a barrier rope so as to release the barrier rope when the calf passes a desired distance from the chute. A receiver is cooperative with the transmitters associated with the first and second switch assemblies. The receiver is adapted to produce a time display indicative of a time between the start timing signal and the stop timing signal.

This foregoing Section is intended to describe, with particularity, the preferred embodiments of the present invention. It is understood that modifications to this preferred embodiment can be made within the scope of the present claims. As such, this Section should not to be construed, in any way, so as to limit the scope of the present invention. The present invention should only be limited by the following claims and their legal equivalents.

### BRIEF DESCRIPTION OF DRAWINGS

FIG. 1 shows the rodeo event timing system of the present invention as used in association with a calf.

FIG. 2 shows the rodeo event timing system of the present invention as applied to a saddle and a lasso.

FIG. 3 is a perspective view showing detailed view of the rodeo event timing system of the present invention.

FIG. 4 is a perspective view showing the receiver associated with the rodeo event timing system of the present invention.

FIG. 5 is a detailed view of the relation between the switch assembly and the transmitter.

### DETAILED DESCRIPTION OF THE INVENTION

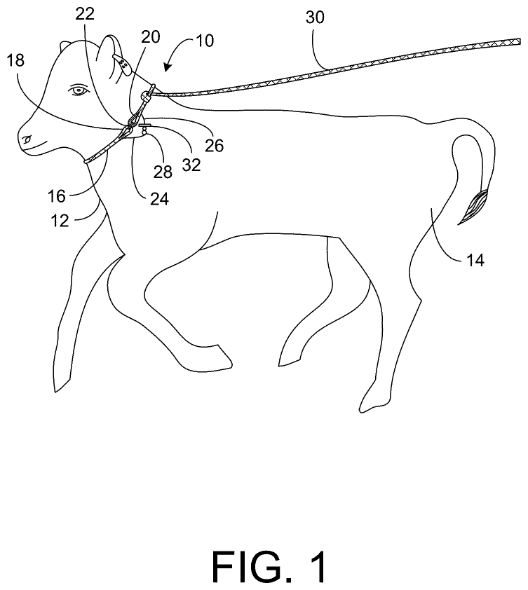

Referring to FIG. 1, there is shown the rodeo event timing system 10 as applied to the neck 12 of a calf 14. The rodeo event timing system 10 includes a neck collar 16 adapted to extend around the neck 12 of the calf 14. The neck collar 16 has ends 18 and 20 releasably secured together by a string 22. The neck collar 16 can be in the nature of a conventional neck collar used in rodeo events. A first cable 24 has one end affixed adjacent to the first end 18 of the neck collar 16. A second cable 26 has one end affixed adjacent to the second end 20 of the neck collar 16. A switch assembly 28 is secured to opposite ends of the first cable 24 and the second cable 26. The switch assembly 28 is adapted to separate when the ends 18 and 20 of the neck collar 16 separate. This produces the start timing signal associated with the rodeo event timing system 10 of the present invention.

As can be seen in FIG. 1, the neck collar 16 has a loop at the first end 18 and a loop at the second end 20. The small string 22 holds these ends together. A lead rope 30 is secured to the neck collar 16 and extends rearwardly of the calf 14. In normal use, when the calf 14 exits the chute, the ends 18 and 20 of the neck collar 16 will separate when the calf 14 reaches a desired distance away from the chute. The force applied by the calf 14 causes the ends 18 and 20 of the neck collar 16 to apply a force to the string 22, thereby breaking the string 22 so as to release the ends and separate the ends. The separation will cause the first cable 24 and the second cable 26 to separate at the switch assembly 28. Once the separation occurs, the magnetic switch associated with the switch assembly 28 of the present invention will send a start timing signal by way of transmitter 32. This start timing signal indicates that the barrier rope has been released and that the calf has moved a desired distance away from the chute.

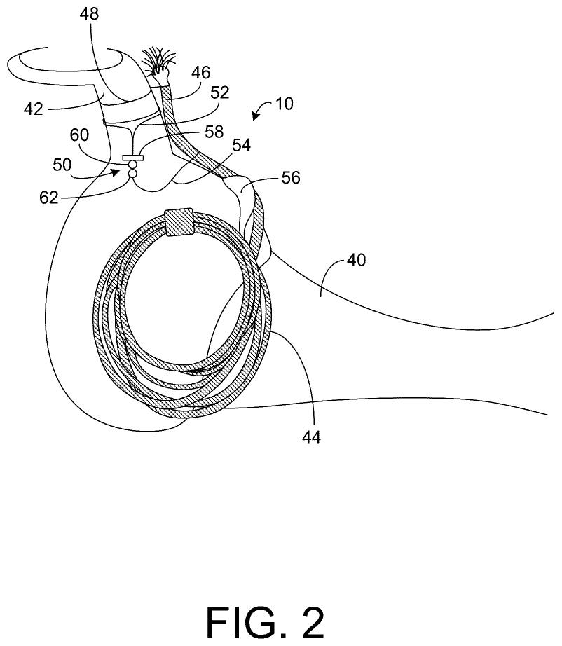

FIG. 2 shows the rodeo event timing system 10 of the present invention as applied to a saddle 40. Saddle 40 has a saddle horn 42 extending outwardly therefrom. Saddle 40 will be applied to the body of a horse. A lasso or lariat 44 is secured adjacent to the saddle. The lasso or lariat 44 will have an end 46 extending along the top of the saddle 40. The end 46 is secured to the saddle horn 42 by a string 48.

A second switch assembly 50 is illustrated as positioned adjacent to a side of the saddle 40. The second switch assembly 50 is similar to the switch assembly used in association with the calf in the manner shown in FIG. 1. The switch assembly 50 includes a third cable 52 and a fourth cable 54. The third cable 52 will extend around the saddle horn 42. The fourth cable 54 will extend outwardly so as to be affixed to the lariat or lasso 44. A flag 56 can be affixed to the rope 44 so as to provide a further visual indication to the referee of the completion of the task associated with the rodeo event.

This portion of the rodeo event timing system 10 of the present invention is particularly adapted for use in association with breakaway roping. When the rider on the saddle 40 ropes the calf, the calf will apply a force on to the rope 46 so as to cause the string 48 to break away from the saddle horn 42. This will cause a force on the fourth cable 54 so as to cause the switch assembly 50 to separate. At this time, a stop signal can be sent by transmitter 58. In this figure, it can be seen that the third cable 52 is associated with a ball 60. The fourth cable 54 is associated with a socket 62.

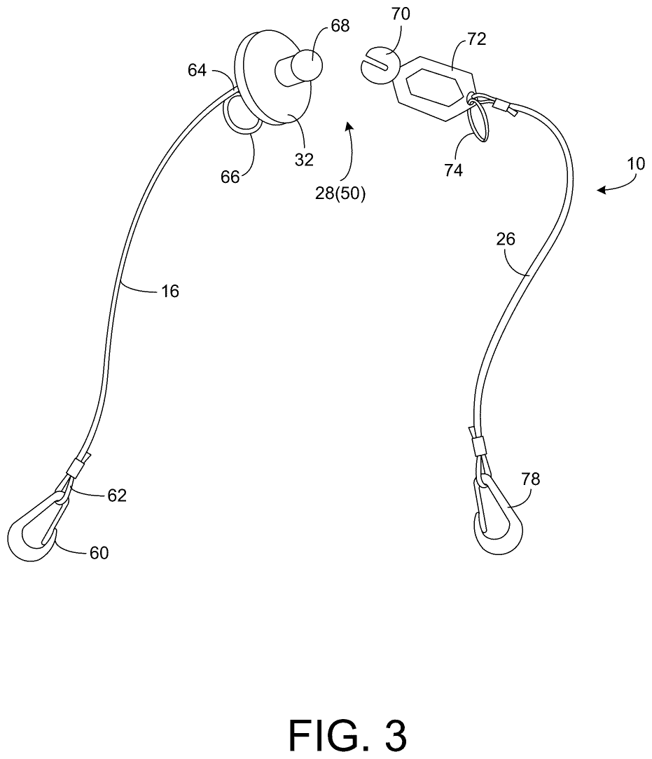

FIG. 3 is a detailed view showing the separate components of the rodeo event timing system 10 of the present invention. In particular, the switch assemblies 28 and 50 are particularly illustrated. In particular, the switch assemblies 28 and 50 will have a generally identical configuration. For the purpose of description, the first switch assembly is shown in FIG. 3 and will be described hereinafter. The first cable 16 extends outwardly from the switch assembly 28. A first clamp 60 is secured to an end 62 of the first cable 16. Clamp 60 is adapted to engage with the neck collar 16 generally adjacent to the end 18. Cable 16 extends so as to have another end 64 secured to the switch assembly 28. A wrap 66 is positioned rearwardly of the transmitter 32. Wrap 66 can be used in association with the embodiment of the present invention used in association with the saddle. In other words, the first clamp 60 can engage with this wrap 66 so as to complete a loop.

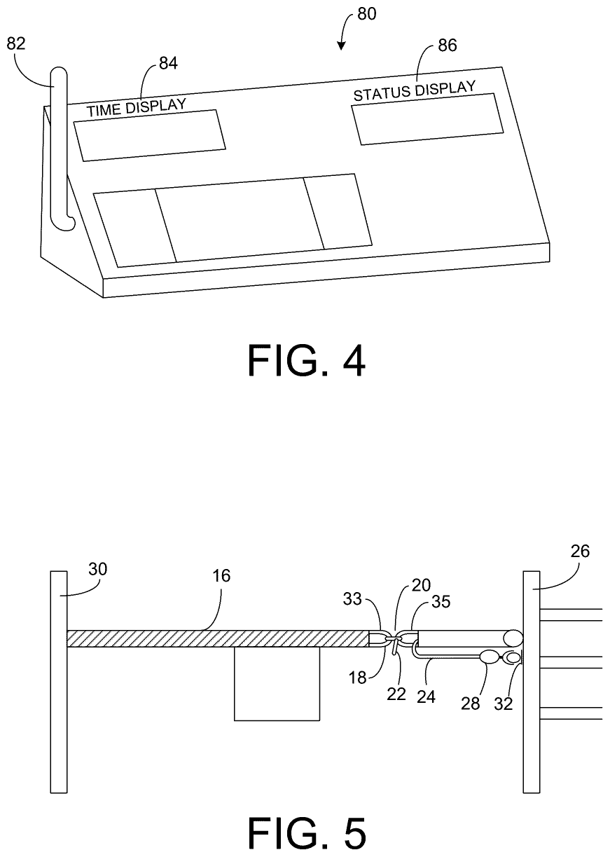

The transmitter 32 is in the form of a disc or a box. Transmitter 32 in the first embodiment is adapted to send a start timing signal. The signal can be sent by radio frequency, Bluetooth, or other means. This signal can be transmitted to the electronic time display as shown here in association with FIG. 4.

The first switch assembly 28 includes a ball 68 extending outwardly from the transmitter 32. Ball 68 is part of the magnetic switch of the switch assembly 28.

There is a socket 70 associated with the opposite side of the switch assembly 28 of the rodeo event timing system 10 of the present invention. Socket 70 is releasably engageable with the ball 68. Since the switch assembly 28 is in the nature of a magnetic switch, the force necessary to separate the ball 68 from the socket 70 is the force which overcomes the magnetic attraction between the ball 68 and the socket 70. Once the socket 70 is separated from the ball 68, the start timing signal begins (or the stop timing signal occurs in the manner shown in FIG. 2). A memory 72 is positioned rearwardly of the socket 70. Another wrap 74 is provided rearwardly of the memory 72. Second cable 26 extends outwardly of the switch assembly 28. Cable 26 extends so as to have a second clamp 78 at the end opposite the socket 70. Clamp 78 can engage with the neck collar (in the manner shown in FIG. 1) or with the lasso (in the manner shown in FIG. 2). The memory 72 is adapted to record, over time, the various start and/or stop timing signals produced during a rodeo event. As such, memory 72 provides a “back-up” of the signals that are transmitted by the transmitter 32 throughout the course of the rodeo event.

FIG. 4 shows a electronic time display 80 as used in the rodeo event timing system 10 of the present invention. Electronic time display 80 includes an antenna 82 adapted to receive the start signal and/or the stop signal as transmitted by the transmitters of the present invention. The electronic time display 80 includes a time display 84 and a status display 86. Electronic time display can be provided in a remote location. As such, the judge of the rodeo event will have direct real-time information as to the time of the particular rodeo event.

FIG. 5 is a detailed view of the switch assembly 28 and the transmitter 32. The switch assembly 28 is connected to the first cable 24. The transmitter is connected to the second cable 26. The neck collar 16 is fastened to the lead rope 30. The neck collar 16 has a loop 33 at end 18 and another loop 35 at end 20. A small breakable string joins the loops 33 and 35 together.

The foregoing disclosure and description of the invention is illustrative and explanatory thereof. Various changes in the details of the illustrated construction can be made is the scope of the present invention without departing from the true spirit of the invention. The present invention should only be limited by the following claims and their legal equivalents.

1. A rodeo event timing system comprising:
a neck collar adapted to extend around a neck of a calf, said neck collar having a first end and a second end releasably secured together;
a first cable having one end affixed adjacent the first end of said neck collar;
a second cable having one end affixed adjacent the second end of said neck collar; and
a switch assembly secured to opposite ends of said first cable and said second cable, said switch assembly being adapted to separate when the ends of said neck collar separate so as to produce a start timing signal.

2. The rodeo event timing system of claim 1, said switch assembly being a magnetic switch.

3. The rodeo event timing system of claim 1, said switch assembly comprising:
a transmitter positioned adjacent the opposite ends of said first cable and said second cable, said transmitter adapted to transmit the start timing signal to a remote location.

4. The rodeo event timing system of claim 3, said switch assembly comprising:
a ball positioned at the opposite end of one of said first and second cable; and
a socket positioned at the opposite end of the other of said first and second cables.

5. The rodeo event timing system of claim 4, said ball being releasably engaged with said socket, the releasing of said ball from said socket causing the start timing signal.

6. The rodeo event timing system of claim 5, said transmitter being positioned in a box positioned rearwardly of said ball.

7. The rodeo event timing system of claim 4, further comprising:
a memory positioned on one of said first and second cables, said memory adapted to receive the start timing signal.

8. The rodeo event timing system of claim 1, further comprising:
a first clamp affixed to the one end of said first cable, said first clamp adapted to engage with said neck collar; and
a second clamp affixed to the one end of said second cable, said second clamp adapted to engage with said neck collar.

9. A rodeo event timing system comprising:
a neck collar adapted to extend around a neck of a calf, said neck collar having ends releasably secured together;
a first cable having one end affixed adjacent the first end of said neck collar;
a second cable having one end affixed adjacent the second end of said neck collar;
a first switch assembly secured to opposite ends of said first cable and said second cable, said first switch assembly adapted to separate when the ends of said neck collar separate so as to produce a start timing signal;
a saddle having a saddle horn, said saddle adapted to be positioned on a horse, the saddle horn extending outwardly of said saddle;
a third cable having one end secured to the saddle horn;
a lasso;
a fourth cable having one end secured to the lasso; and
a second switch assembly connected to opposite ends of said third cable and said fourth cable, said second switch assembly adapted to separate when said lasso separates from the saddle horn so as to produce a stop timing signal.

10. The rodeo event timing system of claim 9, said second switch assembly being a magnetic switch.

11. The rodeo event timing system of claim 9, said lasso been secured by a string to the saddle horn.

12. The rodeo event timing system of claim 9, said second switch assembly comprising a transmitter positioned adjacent to the opposite end of said third cable and said fourth cable, said transmitter adapted to transmit the stop timing signal to the remote location.

13. The rodeo event timing system of claim 12, said second switch assembly comprising:
a ball positioned at the opposite end of one of the third and fourth cables; and
a socket positioned at the opposite end of the other of said third and fourth cables.

14. The rodeo event timing system of claim 13, said ball being releasably engaged with said socket, the releasing of said ball from said socket causing the stop timing signal.

15. The rodeo event timing system of claim 14, said transmitter positioned in a box positioned rearwardly of said ball.

16. The rodeo event timing system of claim 13, further comprising:
a memory positioned on one of said third and fourth cables adjacent to one of said ball and said socket, said memory adapted to receive the stop timing signal.

17. The rodeo event timing system of claim 9, further comprising:
a third clamp fixed to one end of said third cable; and
a fourth clamp affixed to the one end of said fourth cable.

18. The rodeo event timing system of claim 9, further comprising:
a lead rope affixed to said neck rope, said lead rope adapted to connect with a barrier rope so as to release the barrier rope when the calf passes a desired distance from a chute.

19. The rodeo event timing system of claim 9, further comprising:
a receiver cooperative with the transmitters associated with said first and second switch assemblies, said receiver adapted to produce a time display indicative of a time between the start timing signal and the stop timing signal.
